(19) United States
(12) Patent Application Publication
(10) Pub. No.: US 2025/0236044 A1
(43) Pub. Date: Jul. 24, 2025

(54) OFFSET BASE FOR ROUTER

(71) Applicant: MILWAUKEE ELECTRIC TOOL CORPORATION, Brookfield, WI (US)

(72) Inventors: Tyler S. SIGAFOOSE, Pewaukee, WI (US); Jeffery D. SPRAGGON, Pewaukee, WI (US); Andrew D. VAN HOORN, Menomonee Falls, WI (US); Zhenxin DONG, Huizhou City (CN); Ye WANG, Dongguan City (CN)

(21) Appl. No.: 19/173,989

(22) Filed: Apr. 9, 2025

Related U.S. Application Data
(63) Continuation of application No. 17/052,454, filed on Nov. 2, 2020, now Pat. No. 12,285,881.
(60) Provisional application No. 62/848,254, filed on May 15, 2019.

(30) Foreign Application Priority Data
Jan. 20, 2020 (CN) 202020132856.5

(51) Int. Cl. B27C 5/10; B23C 1/20; B23Q 5/04; B23Q 11/12; H02K 7/14; H02K 9/06

(52) U.S. Cl. CPC B27C 5/10; B23C 1/20; B23Q 5/046; B23Q 11/128; H02K 7/145; H02K 9/06; Y10T 409/303976; Y10T 409/306608

(57) ABSTRACT

A router includes a motor unit and a base configured to selectively receive the motor unit to support the router on a work piece surface. The motor unit includes a motor and a spindle configured to output a torque supplied by the motor. The base includes an output shaft laterally offset from the spindle when the motor unit is received into the base, the output shaft including a tool holder. The base also includes a fan configured to generate airflow within the base.

### CROSS-REFERENCE TO RELATED APPLICATIONS

This application is a continuation of U.S. patent application Ser. No. 17/052,454 filed Nov. 2, 2020, which is a national phase filing under 35 U.S.C. § 371 of International Application No. PCT/US2020/032800 filed May 14, 2020, which claims foreign priority to Chinese Utility Model application No. 202020132856.5 filed Jan. 20, 2020, and claims priority to U.S. Provisional Patent Application No. 62/848,254 filed May 15, 2019, the entire contents of each of which are hereby incorporated by reference.

### FIELD OF THE INVENTION

The present invention relates to power tools, and more particularly to powered rotary cutting tools.

### BACKGROUND OF THE INVENTION

Trim routers typically include a motor unit insertable into one or more base units (e.g., a fixed base, a plunge base, an offset base, etc.) to form a router assembly. Many of the offset bases currently available for trim routers utilize a belt and a pulley integral to the output spindle of the motor unit of the router assembly. To operate such offset bases, the pulley must be installed on the motor unit before the motor unit can be inserted into the offset base. Moreover, the belt can only be looped around the pulley after the motor unit has been inserted into the offset base. Often the final step of looping the belt onto the pulley is difficult and time consuming due to the space constraints and limited accessibility to the pulley.

### SUMMARY OF THE INVENTION

In one independent aspect, the present invention provides a router including a motor unit and a base configured to selectively receive the motor unit to support the router on a work piece surface. The motor unit includes a motor and a spindle configured to output a torque supplied by the motor. The base includes an output shaft laterally offset from the spindle when the motor unit is received into the base, the output shaft including a tool holder. The base also includes a fan configured to generate airflow within the base.

In another independent aspect, the present invention provides a router including a motor unit and a base configured to selectively receive the motor unit to support the router on a work piece surface. The motor unit includes a motor and a spindle configured to output a torque supplied by the motor. The base includes a housing, an input shaft including a first pulley, an output shaft including a second pulley and a tool holder, a belt, and a fan. The input shaft is rotatably supported within the housing and is configured to selectively couple to the spindle. The output shaft is rotatably supported within the housing at a location laterally offset from the input shaft. The belt wraps around the first and second pulleys to rotationally couple the input shaft to the output shaft. The fan is coupled for co-rotation with the output shaft to induce an airflow through the housing. When the motor unit is received into the base, the spindle is coupled to the input shaft without removing the belt from the first pulley.

Other features and aspects of the invention will become apparent by consideration of the following detailed description and accompanying drawings.

### BRIEF DESCRIPTION OF THE DRAWINGS

FIG. 1 is a perspective view of a router including a motor unit and a base.

FIG. 2 is a perspective view of the base of FIG. 1.

FIG. 3 is a cross-sectional view of the base of FIG. 1, taken along line 3-3 of FIG. 2.

FIG. 4 is a perspective view of an adapter bit of the router of FIG. 1.

FIG. 5 is a perspective view of the motor unit of FIG. 1.

FIG. 6 is a cross-sectional view of the motor unit of FIG. 1, taken along line 6-6 of FIG. 5

FIG. 7 is a cross-sectional view of portions of the router of FIG. 1, illustrating the motor unit received into the base.

FIG. 8 is another cross-sectional view of the base of FIG. 1, taken along line 8-8 of FIG. 2.

FIG. 9 is a perspective view of a base for use with the motor unit of FIG. 1.

FIG. 10 is another perspective view of the base of FIG. 9, with portions removed.

FIG. 11 is a cross-sectional view of the base of FIG. 9, taken along line 11-11 of FIG. 9.

FIG. 12 is a plan view of a retaining plate of the base of FIG. 9.

FIG. 13 is a plan view of another retaining plate of the base of FIG. 9.

FIG. 14 is a detailed view of the cross-sectional view of FIG. 11.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

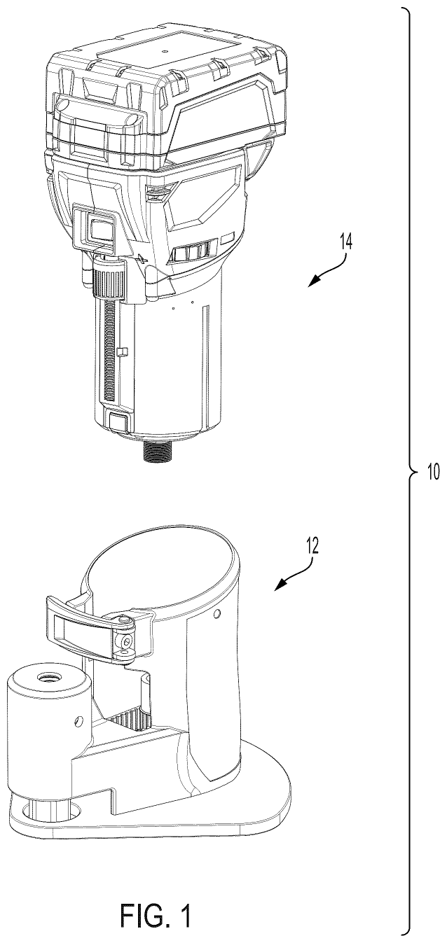

FIG. 1 illustrates a hand-held router 10 according to one embodiment of the invention. The router 10 includes a base 12 and a motor unit 14 supported by the base 12. The motor unit 14 includes a motor 16 operable to drive a tool element (not shown) to cut a workpiece. In the illustrated construction, the base 12 is configured as an offset base.

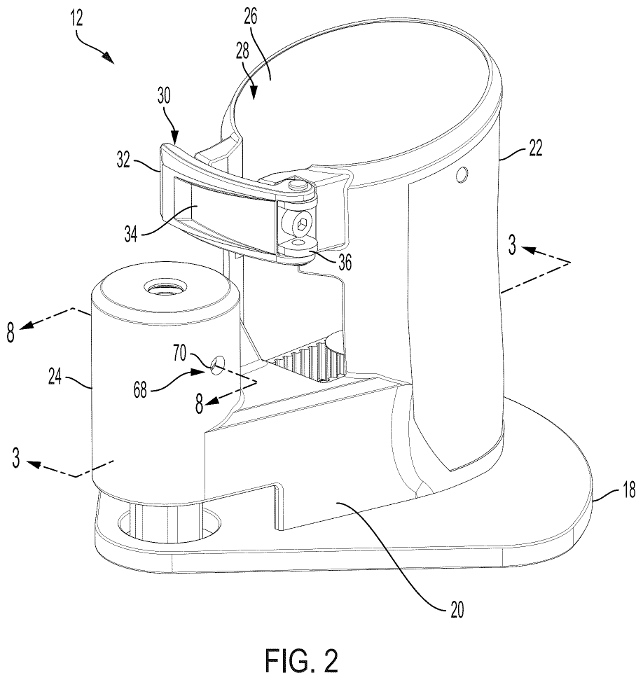

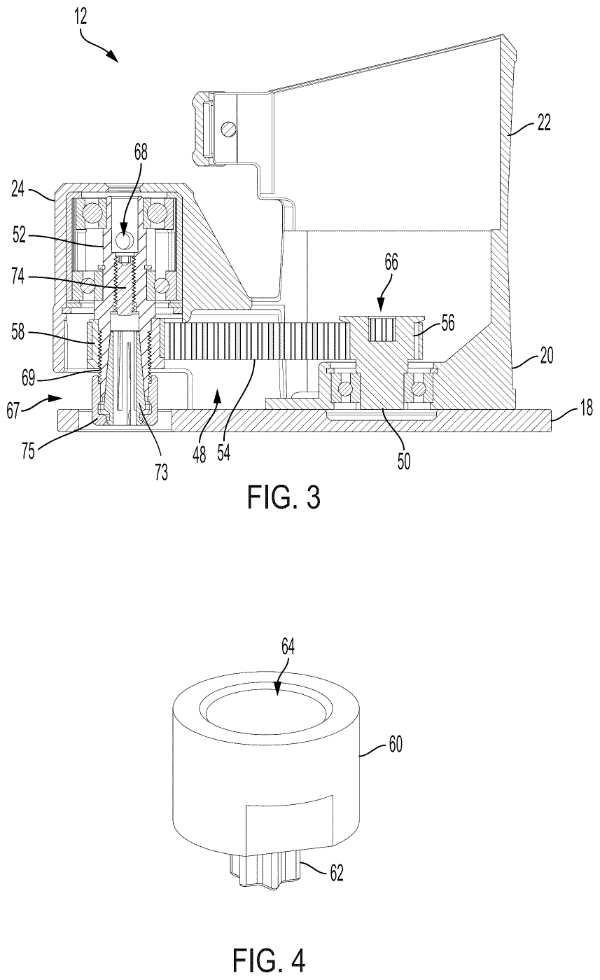

As shown in FIGS. 2 and 3, the base 12 includes a sub-base or base plate 18 configured to interface with a work surface, such as a surface of the workpiece. The base 12 also includes a base housing 20 having a generally cylindrical annular sleeve 22 and an offset housing portion 24 integrally formed with the sleeve 22 and laterally offset therefrom. In the illustrated embodiment, the base housing 20 is fastened to the base plate 18, but in other embodiments (not shown), the base housing 20 may be formed integrally with the base plate 18.

The sleeve 22 of the base 12 extends upwardly from the base plate 18 and includes a generally cylindrical inner surface 26 for interfacing with the motor unit 14. The sleeve 22 is resilient and is open on one side at a vertical seam 28. As a result, the inner diameter of the sleeve 22 may be increased or decreased by opening or partially closing, respectively, the seam 28. The resilience of the sleeve 22 results in the seam 28 being partially open when no force is applied to close the seam 28.

With continued reference to FIGS. 2 and 3, the base 12 includes a clamping mechanism 30 to control the opening and closing of the seam 28. When the seam 28 is partially closed, the base 12 is in a clamped state, in which the motor unit 14 is retained in a fixed position relative to the base 12. When the seam 28 is open, the base 12 is in a released state, in which the motor unit 14 can be inserted into or removed from the base 12. The clamping mechanism 30 includes an actuator or clamp handle 32 having a gripping portion 34 and a cam portion 36. The clamp handle 32 is rotatable to partially close or open the seam 28, and thereby reconfigure the base 12 between the clamped state and the released state.

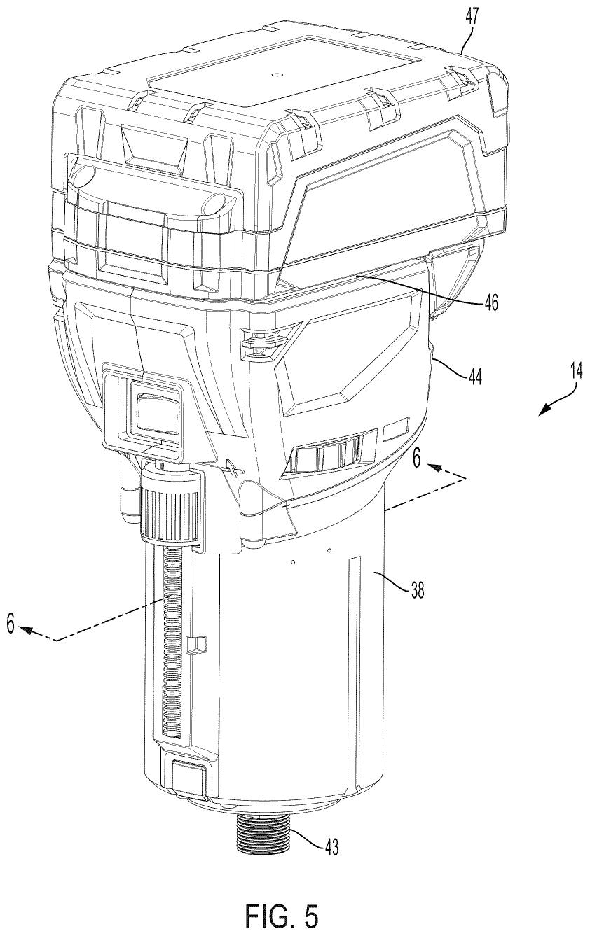

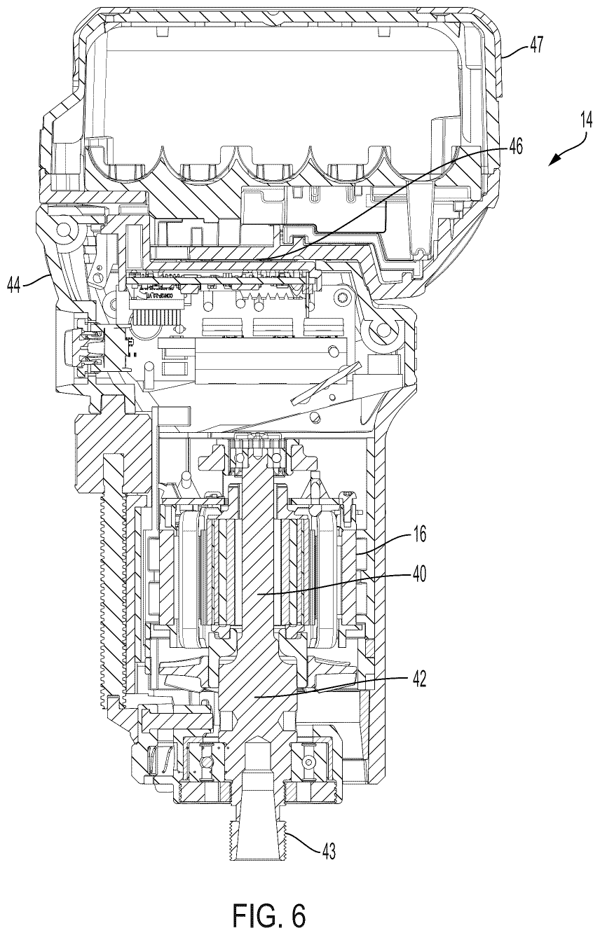

With reference to FIGS. 5 and 6, the motor unit 14 is generally vertically oriented and has a generally cylindrical outer surface 38. The motor unit 14 supports the motor 16 and associated components. The motor 16 includes a motor shaft 40, and a portion of the motor shaft 40 defines a spindle 42 extending outward from the motor unit 14. The spindle 42 is configured to selectively couple to a tool holder (e.g., a collet and nut assembly) configured to support the tool element. The tool holder includes a threaded end 43 of the spindle 42, a collet (not shown) in which the tool element is received, and a nut (not shown) threaded to the threaded end 43 of the spindle 42.

The motor unit 14 also defines a handle portion 44 configured to be grasped by a user. The handle portion 44 defines a battery receptacle 46, which is positioned on an end of the handle portion 44 opposite the spindle 42. The battery receptacle 46 is configured to selectively mechanically and electrically connect to a rechargeable battery pack 47 for powering the motor 16. The battery pack 47 may include any of a number of different nominal voltages (e.g., 12V, 18V, etc.), and may be configured having any of a number of different chemistries (e.g., lithium-ion, nickel-cadmium, etc.). In alternative embodiments (not shown), the motor 16 may be powered by a remote power source (e.g., a household electrical outlet) through a power cord.

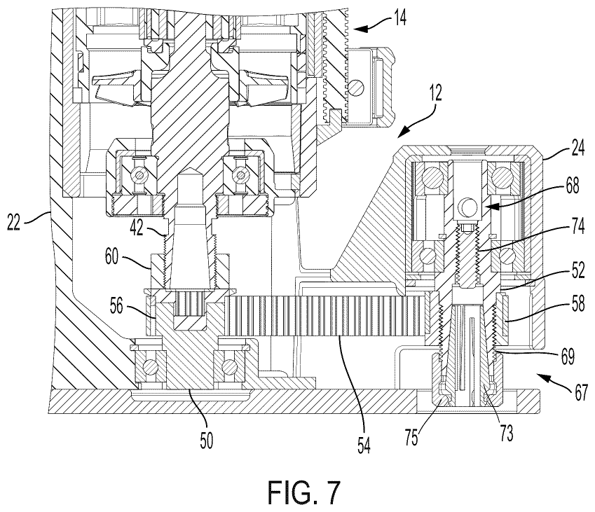

As shown in FIG. 7, the motor unit 14 is arranged to fit within the sleeve 22 and to be vertically fixed relative to the sleeve 22. Closing the seam 28 using the clamping mechanism 30, as described above, causes the inner surface 26 (FIG. 2) of the sleeve 22 to clamp the outer surface 38 (FIG. 5) of the motor unit 14 to secure the motor unit 14 at a fixed position (i.e., height) relative to the base 12. Opening the seam 28 releases the motor unit 14 and allows the motor unit 14 to be removed from the base 12.

Referring back to FIG. 3, the base 12 further includes a drivetrain 48 having an input shaft 50, an output shaft 52, and a belt 54 (e.g., a synchronous belt) that rotatably couples the input shaft 50 to the output shaft 52. The drivetrain 48 also includes a first pulley 56 coupled for co-rotation with the input shaft 50 and a second pulley 58 coupled for co-rotation with the output shaft 52. The belt 54 engages and rotatably couples the first and second pulleys 56, 58 to transfer torque from the input shaft 50 to the output shaft 52. In this regard, the first and second pulleys 56, 58, and the belt 54, are included as integral components of the base 12, such that the pulleys 56, 58 and the belt 54 remain with the base 12 when the motor unit 14 is removed from the base 12. Prior-art offset bases for trim routers typically utilize a pulley integral to the output spindle of the motor unit, requiring the user to manually wrap the belt around the pulley after the router is inserted into the offset base. In contrast, with the base 12, the belt 54 remains wrapped around the pulleys 56, 58 at all times, obviating the need to remove and/or attach the belt 54 to the motor unit 14 when it is inserted or removed from the base 12.

The input shaft 50 is rotatably supported within the sleeve 22 of the base 12. When the motor unit 14 is inserted into the base 12, the spindle 42 rotatably couples to the input shaft 50. Specifically, in the illustrated embodiment, the router 10 includes an adapter bit 60 (FIG. 4), which can be threaded to the threaded end 43 of the spindle 42 after the collet and nut are removed, to facilitate quick-attachment and quick-removal between the base 12 and the motor unit 14. The adapter bit 60 includes a male connection member 62 and a threaded bore 64 into which the threaded end 43 of the spindle 42 is received. In turn, the input shaft 50 defines a female hub 66 (FIG. 3) having a shape corresponding to that of the male connection member 62. When the motor unit 14 is inserted into the base 12, the male connection member 62 of the adapter bit 60 engages the female hub 66 (e.g., by a nominal slip-fit) as shown in FIG. 7 to rotationally unitize the spindle 42 and the input shaft 50. In alternative embodiments (not shown), the arrangement may be reversed, such that the adapter bit 60 defines the female hub and the input shaft 50 includes the male connection member.

Referring once more to FIG. 3, the output shaft 52 is rotatably supported within the offset housing portion 24 of the base 12. The output shaft 52 includes a tool holder 67 that receives and supports a tool element (not shown). The tool holder 67 includes a threaded end 69 of the output shaft 52, a collet 73 in which the tool element is received, and a nut 75 threaded to the threaded end 69 of the output shaft 52. When threaded onto the threaded end 69 of the output shaft 52, the nut 75 applies an axial clamping force to the collet 73, which is then converted to a radial clamping force on the collet 73 to clamp the tool element within the collet 73.

To operate the motor unit 14 with the base 12, the adapter bit 60 is attached to the spindle 42 by tightening the threaded bore 64 onto the threaded end of the spindle 42. With the base 12 in the released state (i.e., with the seam 28 open), the motor unit 14 is inserted into the sleeve 22 so that the male connection member 62 engages the female hub 66 of the input shaft 50. The clamp handle 32 is rotated to partially close the seam 28 and place the base 12 in the clamped state, and thereby secure the motor unit 14 within the base 12. The motor 16 is activated to rotate the spindle 42, and rotation of the spindle 42 drives the input shaft 50. Torque is transferred from the input shaft 50 to the output shaft 52 via the belt 54 to drive a tool element (not shown) attached to the tool holder 67. In this way, the offset base permits cuts to be made in the workpiece at locations that may be difficult or impossible for a traditional router to access (e.g., locations proximate edges, corners, or other obstructions).

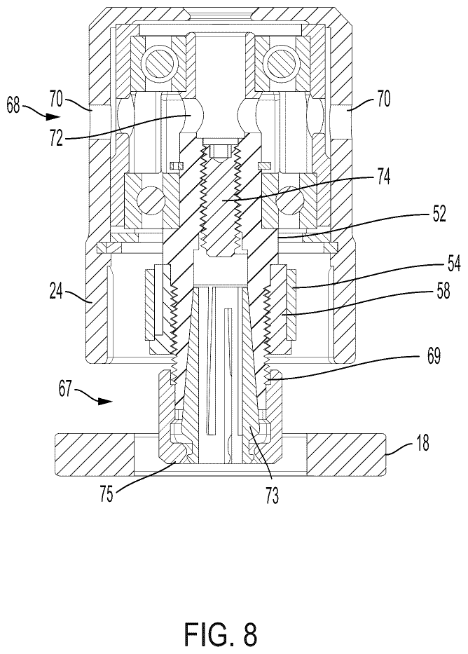

With reference to FIG. 8, the base 12 also includes a keyway 68 including a pair of first openings 70 defined in the offset housing portion 24, and a corresponding second opening 72 defined in the output shaft 52 proximate the first openings 70. Spindle lock is achieved by inserting a tool (e.g., an Allen key; not shown) into the keyway 68 and through at least one of the first and second openings 70, 72, to prevent the output shaft 52 from rotating as the tool holder 67 is loosened or tightened to remove or insert a tool element, respectively.

The output shaft 52 also includes an adjustable set screw 74 rotatable relative to the output shaft 52 to adjust a cutting depth of the tool element. The set screw 74 resides within a central bore of the output shaft 52. The set screw 74 may be rotated to move toward or away from the tool holder 67 along the vertical direction, thereby increasing or decreasing an extent to which the tool element may be inserted into the tool holder 67.

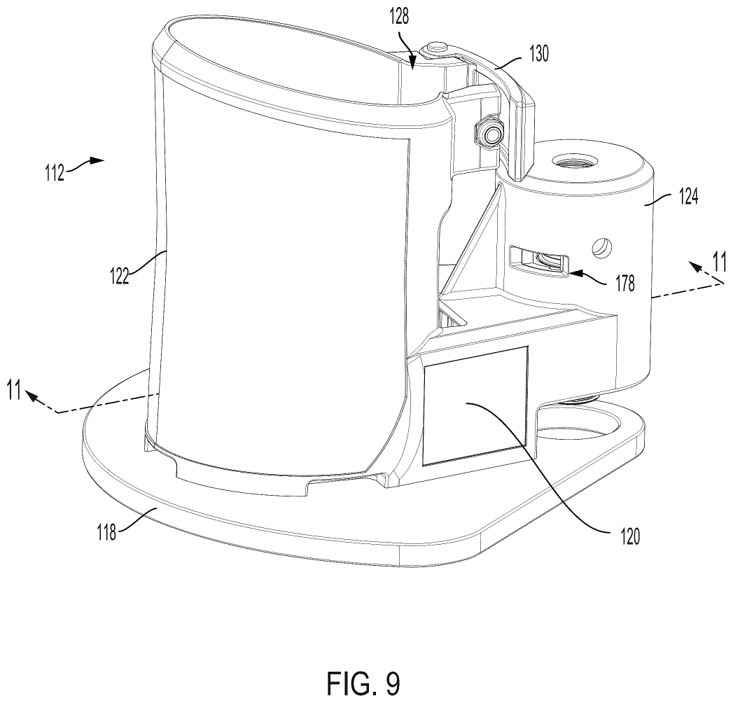

FIGS. 9-11 illustrate a base 112 according to another embodiment of the invention. The base 112 is similar to the base 12 described above and includes substantially the same structure as the base 12. Likewise, the base 112 selectively receives and slidably supports the motor unit 14 in a manner similar to that described above with respect to the base 12. Accordingly, the following description focuses primarily on the structure and features of the base 112 that are different from the embodiments of the base 12 described above in connection with FIGS. 1-8. Features and elements of the base 12 that are described in connection with FIGS. 1-8 are numbered in the 100 series of reference numerals in FIGS. 9-11. It should be understood that the features of the base 112 that are not explicitly described below have the same properties as the features of the base 12.

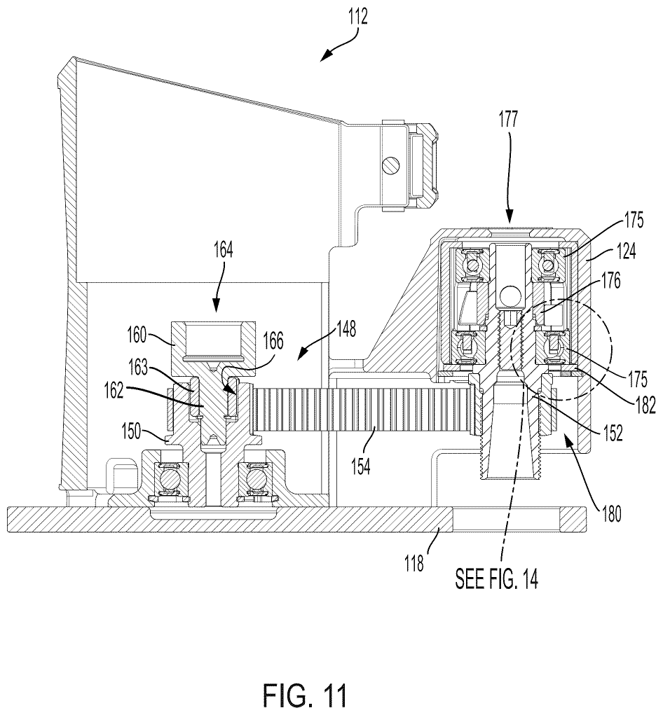

The base 112 includes a base plate 118 and a base housing 120, the base housing 120 having a generally cylindrical annular sleeve 122 and an offset housing portion 124. The base 112 also includes a clamping mechanism 130 to control the opening and closing of a scam 128, and a drivetrain 148 having an input shaft 150 and an output shaft 152 rotatably coupled to the input shaft 150 by a belt 154 (e.g., a synchronous belt). The output shaft 152 is rotatably supported within the offset housing portion 124 by a pair of bearings 175 positioned between the output shaft 152 and the offset housing portion 124. The output shaft 152 supports a cooling fan 176 for co-rotation with the output shaft 152. The offset housing portion 124 defines an inlet opening 177 located adjacent an upper end of the output shaft 152, and outlet openings 178 located adjacent and radially outboard of the cooling fan 176. The offset housing portion 124 further defines a bottom opening 180 proximate and in facing relationship with the base plate 118. Although not shown in FIG. 11, a tool holder, similar to the tool holder 67 described above and illustrated in FIG. 8, is incorporated at the end of the output shaft 152 protruding from the bottom opening 180 for clamping a tool element.

In operation, the cooling fan 176 generates a cooling airflow within the offset housing portion 124 for cooling the offset base 112, including the drivetrain 148, the offset housing portion 124, and the cutting tool clamped to the tool holder (not shown). The cooling fan 176 draws outside air through the inlet opening 177, and directs the air toward the outlet openings 178 where the air is discharged radially outward. As the output shaft 152 rotates during operation, friction developed within the bearings 175 can generate heat and raise the operating temperature of, e.g., the drivetrain 148, the offset housing portion 124, and the cutting tool. The cooling airflow helps to prevent the operating temperatures of these components from getting too undesirably hot, which is a common issue with traditional offset bases.

In some embodiments (not shown), it is further contemplated that the inlet and/or the outlet openings may be relocated in relation to the offset housing portion 124. For example, an outlet opening may be located at or proximate the bottom opening 180, such that the cooling air is downwardly discharged around the tool holder and toward the baseplate 118 (and thus the work piece surface) rather than radially outward.

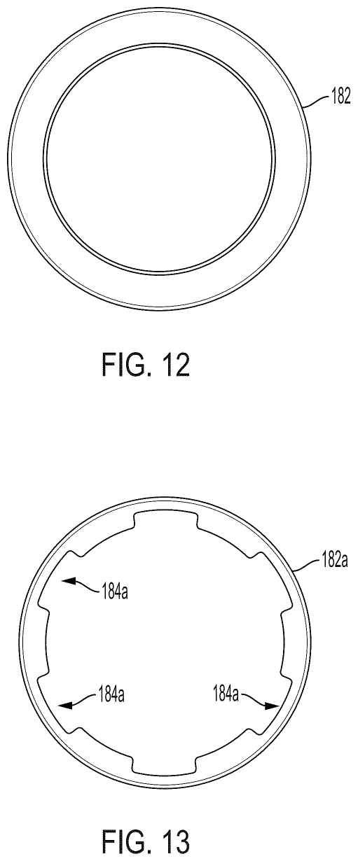

With reference to FIGS. 11 and 12, the illustrated base 112 includes a retaining plate 182 located within the offset housing portion 124 and abutting the lower bearing 175. The retaining plate 182 effectively closes off the offset housing portion 124 near the lower bearing 175, thus obstructing the cooling airflow generated by the cooling fan 176 from discharging toward the bottom opening 180.

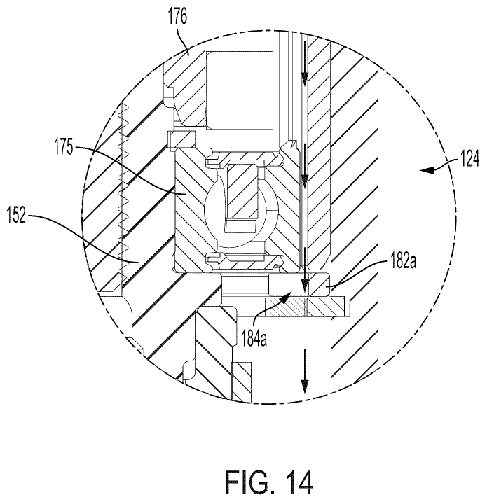

With reference to FIGS. 13 and 14, in some embodiments, the base 112 includes a notched retaining plate 182a having circumferentially spaced radial notches 184a. The radial notches 184a permit a portion of the cooling airflow generated by the cooling fan 176 to flow downward toward the bottom opening 180, as indicated by the arrows shown in FIG. 14. The portion of the cooling airflow that passes through the notches 184a provides additional cooling to the lower bearing 175.

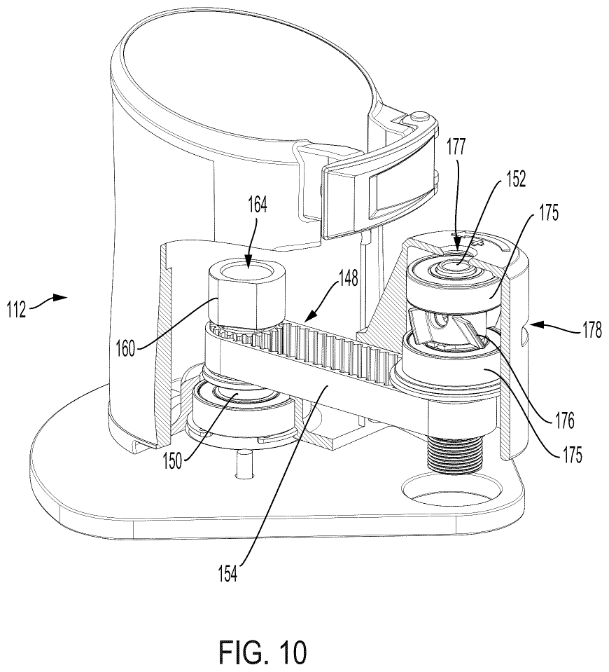

FIGS. 10 and 11 also show an adapter 160 similar to the adapter bit 60 described above and shown in FIG. 4. Like the adapter bit 60, the adapter bit 160 can likewise be threaded to the threaded end 43 of the spindle 42 to facilitate quick-attachment and quick-removal between the base 112 and the motor unit 14. The adapter bit 160 includes a threaded bore 164 into which the threaded end 43 of the spindle 42 is received. The adapter bit 160 also includes a male connection member 162 that differs somewhat from the male connection member 62 described above. Specifically, the illustrated male connection member 162 includes a square-shaped boss 162, and a damper 163 located about the square-shaped boss 162. In turn, the input shaft 150 of the base 112 defines a female hub 166 having a shape corresponding to that of the male connection member 162. When the motor unit 14 is fitted with the adapter bit 160 and inserted into the base 112, the male connection member 162 of the adapter bit 160 engages the female hub 166 (e.g., by a nominal slip-fit) as shown in FIG. 11 to rotationally unitize the spindle 42 and the input shaft 150. When thus arranged, the damper 163 resides between the walls of the female hub 166 and the square-shaped boss 162 and attenuates mechanical vibration and noise during operation of the base 112.

Various features of the invention are set forth in the following claims.

What is claimed is:

1. A router comprising:
a motor unit including a motor and a spindle configured to output a torque supplied by the motor; and
a base configured to selectively receive the motor unit to support the router on a work piece surface, the base including
an output shaft laterally offset from the spindle when the motor unit is received into the base, the output shaft including a tool holder; and
a fan configured to generate an airflow within the base.

2. The router of claim 1, wherein the fan is supported on the output shaft for co-rotation therewith.

3. The router of claim 1, wherein the fan receives torque from the motor to generate the airflow.

4. The router of claim 1, wherein the base includes a housing that defines an inlet opening, and wherein the fan draws air through the inlet opening into the base.

5. The router of claim 4, wherein the housing further includes an outlet opening, and wherein air is discharged by the fan through the outlet opening.

6. The router of claim 5, wherein the outlet opening is located radially outboard of the fan.

7. The router of claim 1, wherein when the motor unit is received into the base, the spindle couples to the output shaft.

8. The router of claim 7, wherein the base further comprises:
an input shaft configured to selectively couple to the spindle, the input shaft laterally offset from the output shaft and including a first pulley;
a second pulley coupled for co-rotation with the output shaft; and
a belt wrapped around the first and second pulleys to rotationally couple the input shaft to the output shaft.

9. A router comprising:
a motor unit including a motor and a spindle configured to output a torque supplied by the motor; and
a base configured to selectively receive the motor unit to support the router on a work piece surface, the base including
a housing;
an input shaft rotatably supported within the housing and configured to selectively couple to the spindle, the input shaft including a first pulley;
an output shaft rotatably supported within the housing at a location laterally offset from the input shaft, the output shaft including a second pulley and a tool holder;
a belt wrapped around the first and second pulleys to rotationally couple the input shaft to the output shaft; and
a fan coupled for co-rotation with the output shaft to induce an airflow through the housing;
wherein when the motor unit is received into the base, the spindle is coupled to the input shaft without removing the belt from the first pulley.

10. The router of claim 9, further comprising an adapter bit configured to attach to the spindle and configured to couple the spindle to the input shaft.

11. The router of claim 9, wherein the housing includes a keyway configured receive a key to lock the output shaft against rotation.

12. The router of claim 9, wherein the tool holder is configured to support a tool element, and wherein the base includes a set screw rotatable to adjust a cutting depth of the tool element.

13. The router of claim 9, wherein the belt is configured as a synchronous belt.

14. The router of claim 9, wherein the housing includes an inlet opening located adjacent an upper end of the output shaft, wherein the fan is configured to draw air through the inlet opening into the base, wherein the housing includes an outlet opening radially outboard of the fan, and wherein the fan is configured to discharge the air through the outlet opening out from the base.

15. The router of claim 9, wherein the motor includes a motor shaft, and wherein a portion of the motor shaft defines the spindle.

16. The router of claim 9, wherein the housing includes a sleeve, and wherein the motor unit is insertable into the sleeve.

17. The router of claim 9, wherein the base further includes a first bearing that rotatably supports the output shaft and a second bearing that rotatably supports the output shaft.

18. The router of claim 17, wherein the housing includes a retaining plate adjacent the second bearing, the retaining plate defining a radial notch, and wherein the fan is configured to generate an airflow that passes through the radial notch and toward the tool holder.

19. The router of claim 9, wherein the base further includes a first bearing that rotatably supports the input shaft and a second bearing that rotatably supports the output shaft.

20. The router of claim 9, wherein the base includes a base plate coupled to the housing, the base plate being configured to interface with the work piece surface.
